(19) United States
(12) Patent Application Publication
(10) Pub. No.: US 2024/0254292 A1
(43) Pub. Date: Aug. 1, 2024

(54) MASTER BATCH COMPOSITION FOR A WEIGHT-REDUCED PLASTIC PRODUCT AND METHOD OF MANUFACTURING THE SAME

(71) Applicant: Nano and Advanced Materials Institute Limited, Hong Kong (HK)

(72) Inventors: Yueying CHEN, Hong Kong (HK); Qi JIANG, Hong Kong (HK); Dongli SUN, Hong Kong (HK); Xianqiao LIU, Hong Kong (HK)

(21) Appl. No.: 18/635,031

(22) Filed: Apr. 15, 2024

Related U.S. Application Data
(63) Continuation-in-part of application No. 17/830,366, filed on Jun. 2, 2022.

(51) Int. Cl. C08J 3/22; B29C 44/34; B29C 49/00; B29C 49/04; B29K 23/00; B29K 105/04; C08J 9/14; C08J 9/228; C08L 23/06

(52) U.S. Cl. CPC C08J 3/22; B29C 44/3449; B29C 49/0005; B29C 49/04; C08J 9/141; C08J 9/228; C08L 23/06; B29K 2023/0608; B29K 2105/048; B29K 2995/0097; C08J 2203/14; C08L 2207/53

(57) ABSTRACT

A master batch composition for a weight-reduced plastic product includes a bi-component carrier resin, a core-shell foaming agent, and at least one lubricant. The core-shell foaming agent includes at least one outer polymeric shell and at least one inner foaming agent core. The outer polymeric shell encapsulates the inner foaming agent core. The inner foaming agent core includes alkane. The master batch composition is configured to be integrated into the weight-reduced plastic product by extrusion blow molding with a base plastic resin to create a foamed plastic having a foaming pore size from 10 to 80 μm.

### CROSS-REFERENCE TO RELATED APPLICATION

The present application is a continuation-in-part of U.S. patent application Ser. No. 17/830,366, filed Jun. 2, 2022, the disclosures of which are incorporated by reference herein.

### FIELD OF THE INVENTION

The invention relates to the technical field of extrusion blow molding of plastic products. In particular, it relates to a master batch composition for a weight-reduced plastic product produced by blow molding.

### BACKGROUND OF THE INVENTION

Foamed plastic is usually prepared by extrusion foaming, foam injection molding, or bead foaming. The polymer resin is fed into an extruder or molding machine and undergoes a series of reactions to form the final product. When manufacturing foamed plastic products, uneven pores distribution can easily lead to flaws in the final plastic products, for example big pores and uneven thickness. These defects may result in lower mechanical strength and unappealing visual defects.

When additives, such as foaming agents, are added to the feeding mixture which includes the polymer resin, a different particle size is also introduced between the feeding mixture and agents. The additives usually come in the form of a powder. The broad size difference between the powder particles and the particles in the feeding mixture further increases the likelihood of defects in the final products. There is a need to provide a feeding mixture with a uniform particle size.

### SUMMARY OF THE INVENTION

This section is for the purpose of summarizing some aspects of embodiments of the invention and to briefly introduce some further embodiments. In this section, as well as in the abstract and the title of the invention of this application, simplifications or omissions may be made to avoid obscuring the purpose of the section, the abstract and the title, and such simplifications or omissions are not intended to limit the scope of the invention.

The present invention has been made in view of the above-mentioned problems of the need of even particle size distribution in a master batch composition for a plastic product.

Accordingly, one aspect of the present invention provides a master batch composition for a weight-reduced plastic product includes a carrier resin, a core-shell foaming agent, and at least one lubricant. The core-shell foaming agent includes at least one outer polymeric shell and at least one inner foaming agent core. The outer polymeric shell encapsulates the inner foaming agent core. The inner foaming agent core includes alkane. The master batch composition is configured to be integrated into the weight-reduced plastic product by extrusion blow molding with a base plastic resin to create a foamed plastic having a foaming pore size from 10 to 80 μm.

In a further embodiment of the present invention, the bi-component carrier resin includes thermoplastic polymers and their blends which have a melting temperature in a range between 50 and 160° C.

In a further embodiment of the present invention, the thermoplastic polymers and their blends selected from polyethylene (PE) and ethylene vinyl acetate (EVA).

Preferably, the bi-component carrier resin is the copolymer of ethylene vinyl acetate (EVA) and Linear low-density polyethylene (LLDPE).

In a further embodiment of the present invention, polyethylene comprises one or more linear low-density polyethylene, low-density polyethylene, and high-density polyethylene.

In a further embodiment of the present invention, the content of bi-component carrier resin ranges between 40 and 90 wt %.

In a further embodiment of the present invention, the outer polymeric shell is selected from poly lactic acid (PLA), poly(lactic-co-glycolic acid)(PLGA), polystyrene (PS), poly methacrylate (PMA), poly methyl Methacrylate (PMMA), or polymers comprising one or more monomers of acrylonitrile, methacrylonitrile, 3-butene nitrile, methacrylate, ethyl acrylate, propyl acrylate, butyl acrylate, methyl methacrylate, methyl ethyl acrylate, glycidyl methacrylate, or any combination thereof, and the inner foaming agent core is selected from pentane, butane, n-hexane, n-heptane, isooctane or any combination thereof.

In a further embodiment of the present invention, the thickness of the outer polymeric shell is approximately between 0.5 and 2 μm.

In a further embodiment of the present invention, the content of core-shell foaming agent ranges between 10 and 50 wt %.

In a further embodiment of the present invention, the content of lubricant ranges between 1 and 30 wt %.

In a further embodiment of the present invention, at least one lubricant includes one or more lubricant selected from paraffin oil, paraffin wax, stearic acid and their blends.

In a further embodiment of the present invention, the weight-reduced plastic product has a master batch composition ranging between 1 and 10 wt %.

In a further embodiment of the present invention, the base plastic resin includes one or more polyethylene and polypropylene.

Another aspect of the present invention provides a method of preparing a master batch composition for weight-reduced plastic includes mixing a master batch composition to form a melt mixture in an internal mixer at a first temperature ranging between 50 and 160° C. The master batch composition includes a carrier resin, a core-shell foaming agent, and at least one lubricant. The core-shell foaming agent includes at least one outer polymeric shell and at least one inner foaming agent core. The outer polymeric shell encapsulates the inner foaming agent core. The inner foaming agent core includes alkane. Then the melt mixture is single-screw extruded and pelletized at a second temperature ranging between 50 and 160° C. to form pellets.

In a further embodiment of the present invention, the master batch composition includes 40 to 90 wt % of the carrier resin, 10 to 50 wt % of the core-shell foaming agent, and 1 to 30 wt % of at least one lubricant.

In a further embodiment of the present invention, the method further includes mixing the master batch composition in a form of pellets with a base plastic resin to form a molding mixture in an internal mixer. Next, the molding mixture is single-screw extruded at a temperature ranging between 180 and 220° C. to form a product preform. Followed by the single-screw extruding, the product preform is blow molded to form a plastic product.

In a further embodiment of the present invention, the single-screw extruding includes a die temperature ranging between 170 and 230° C., a screw rotation speed ranging between 15 and 17 Hz, and a blow pressure ranging between 0.25 and 0.6 MPa.

### BRIEF DESCRIPTION OF THE DRAWINGS

In order to more clearly illustrate the technical solutions of the embodiments of the present invention, the drawings needed to be used in the description of the embodiments will be briefly introduced below. It is obvious that the drawings in the following description are only some embodiments of the present invention, and it is obvious for those skilled in the art to obtain other drawings based on these drawings without inventive exercise, in which:

FIG. 1 is a flow chart showing a method of preparing a master batch composition for weight-reduced plastic according to the present invention;

FIG. 2A is a schematic diagram of a master batch composition before internal mixing according to the present invention;

FIG. 2B is a schematic diagram of a master batch composition pellets according to the present invention;

FIG. 3 is a cross-sectional, schematic diagram of an individual core-shell foaming agent according to the present invention;

FIG. 4 is a schematic diagram of single-screw-extruding a master batch composition melt mixture according to the present invention;

FIG. 5 is a flow chart showing a method of manufacturing a weight-reduced plastic product according to the present invention;

FIG. 6 is a schematic diagram of single-screw-extruding a molding mixture according to the present invention;

FIG. 7 is a schematic diagram of blow molding a product preform according to the present invention;

FIG. 8A is an SEM image of a foamed plastic bottle according to the present invention;

FIG. 8B is a particle distribution plot of a foamed plastic bottle according to the present invention;

FIG. 9A is an SEM image of a foamed plastic bottle according to the present invention;

FIG. 9B is a particle distribution plot of a foamed plastic bottle according to the present invention;

FIG. 10A is an SEM image of a foamed plastic bottle according to the present invention;

FIG. 10B is a particle distribution plot of a foamed plastic bottle according to the present invention;

FIG. 11A is an SEM image of a foamed plastic bottle according to the present invention;

FIG. 11B is a particle distribution plot of a foamed plastic bottle according to the present invention;

FIG. 12A is an SEM image of a foamed plastic bottle according to the present invention;

FIG. 12B is a particle distribution plot of a foamed plastic bottle according to the present invention;

FIG. 13A is an SEM image of a foamed plastic bottle according to the present invention;

FIG. 13B is a particle distribution plot of a foamed plastic bottle according to the present invention;

FIG. 14A shows images showing the appearance of the foamed plastic bottles using commercial foaming agent and foaming masterbatch in this invention; and

FIG. 14B depicts pore size distribution of the foamed plastic bottles using commercial foaming agent and foaming masterbatch in this invention.

### DETAILED DESCRIPTION OF THE INVENTION

In order to make the aforementioned objects, features and advantages of the present invention comprehensible, embodiments accompanied with figures are described in detail below.

In the following description, numerous specific details are set forth in order to provide a thorough understanding of the present invention, but the present invention may be practiced in other ways than those specifically described and will be readily apparent to those of ordinary skill in the art without departing from the spirit of the present invention, and therefore the present invention is not limited to the specific embodiments disclosed below.

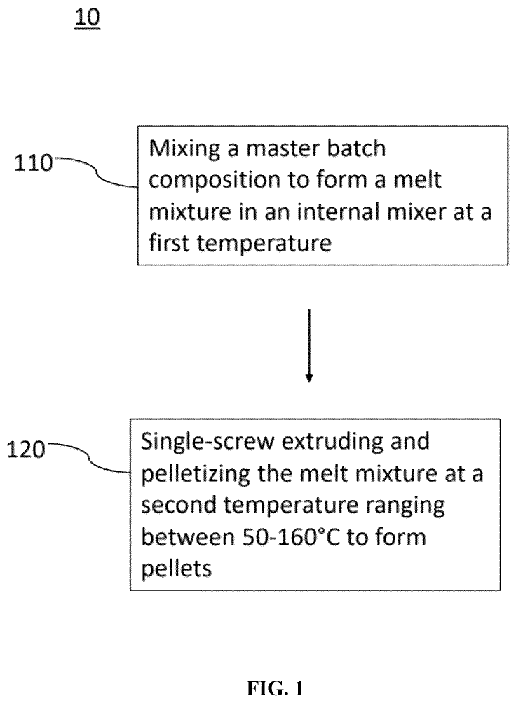

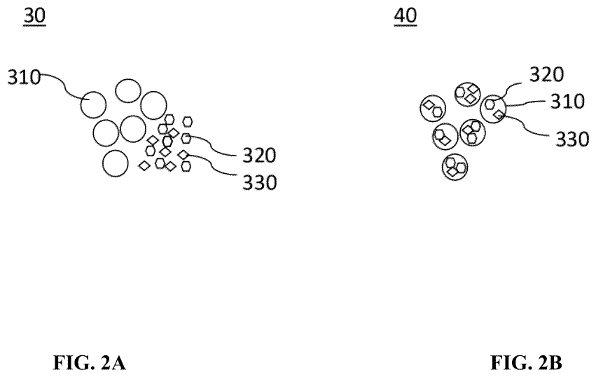

The present invention provides a method of preparing a master batch composition for weight-reduced plastic. Turning to FIG. 1, a method 10 shows the steps in the method of preparing a master batch composition for weight-reduced plastic. First, in step 110, a master batch composition is mixed to form a melt mixture in an internal mixer at 50 to 160° C. Turning to FIG. 2A in conjunction with FIG. 1, the master batch composition 30 includes a bi-component carrier resin 310, a core-shell foaming agent 320, and at least one lubricant 330. The components of the master batch composition are mixed thoroughly in the internal mixer and melted to a molten liquid state. The bi-component carrier resin includes thermoplastic polymers and their blends. The bi-component carrier resin has a melting temperature ranging between 50 and 160° C. The range of melting temperatures of the bi-component carrier resin reflects the first temperature used in the step of mixing. After mixing, the core-shell foaming agents 320 and lubricant 330 are dispersed evenly in the bi-component carrier resin 310. This mixing will save the material from undergoing a pre-foaming step. In an embodiment, the thermoplastic polymers and their blends of the bi-component carrier resin may be polyethylene (PE) or Ethylene Vinyl Acetate (EVA). The PE includes one or more linear low-density PE, low-density polyethylene, and high-density PE. The content of bi-component carrier resin ranges between 40 and 90 wt %.

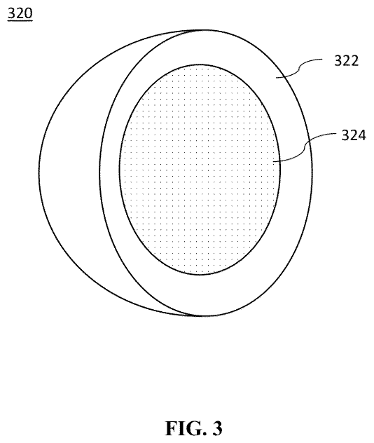

Turning to FIG. 3, a cross-sectional schematic diagram shows an individual core-shell foaming agent 320 including an outer polymeric shell 322 and an inner foaming agent core324. The outer polymeric shell 322 encapsulates the inner foaming agent core324 to form a spherical particle. The outer polymeric shell 322 is made of polymers being selected from poly lactic acid (PLA), poly(lactic-co-glycolic acid) (PLGA), polystyrene (PS), poly methacrylate (PMA), poly methyl methacrylate (PMMA), polymers includes one or more monomers of acrylonitrile, methacrylonitrile, 3-butene nitrile, methacrylate, ethyl acrylate, propyl acrylate, butyl acrylate, methyl methacrylate, methyl ethyl acrylate, glycidyl methacrylate, or any combination thereof. The thickness of the outer polymeric shell ranges between 0.5 and 2 μm. The inner foaming agent core324 is made of alkanes. In an embodiment, the alkanes of the inner foaming agent core324 are selected from C₄ to C₉ alkanes, for example pentane, butane, n-hexane, n-heptane, isooctane or any combination thereof. A size distribution of the core-shell foaming agent 320 is between 5 and 100 μm. The content of core-shell foaming agent in the master batch composition ranges between 10 and 50 wt %. The lubricant of the master batch composition is selected from paraffin oil, paraffin wax, stearic acid and their blends. The content of lubricant ranges between 1 and 30 wt %.

In one embodiment, the bi-component carrier resin is the copolymer of ethylene vinyl acetate (EVA) and Linear low-density polyethylene (LLDPE). The EVA functions as a protective layer, providing room for expansion for the expandable core-shell foaming agents, while also preventing the collapse of expanded foam pores under high blowing pressure (e.g., 0.25-0.6 MPa).

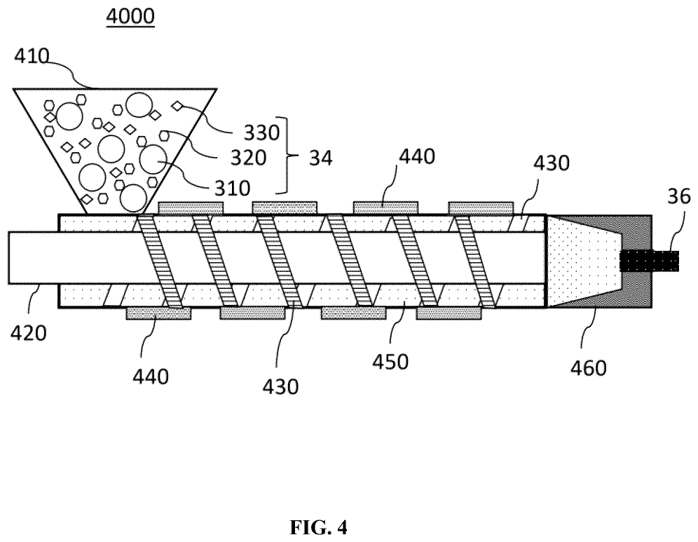

Referring back to FIG. 1, in step 120, the melt mixture undergoes single-screw extrusion and then pelletizing at 50 to 160° C. to form pellets. The internal mixer is a separate machine from an extruder to avoid over-heating of the single-screw extruder. After thoroughly mixing the master batch composition into a molten state, the master batch composition is transferred to the single-screw extruder 4000. Turning to FIG. 4, a schematic diagram of a single-screw extruder 4000 is shown. The single-screw extruder 4000 includes a hopper 410 that receives material from the internal mixer. The material is then fed into a barrel 450. A single screw 420 is fitted in the barrel 450. A screw thread 430 wraps around the cylindrical single screw 420. Heaters 440 are disposed on the outer surface of the barrel 450. A nozzle 460 is formed at one end of the barrel 450. The melt mixture 34 which includes the bi-component carrier resin 310, core-shell foaming agent 320, and lubricant 330 is directed to the hopper 410 from the internal mixer. It should be understood that the melt mixture 34, as shown in FIG. 4, is a representative illustration. The melt mixture 34 is in a molten state, and the materials are well dispersed in the bi-component carrier resin 310. Next, the melt mixture 34 is fed into the barrel 450. The single screw 420 rotates along a predetermined direction and drives the melt mixture 34 inches forward inside the barrel 450. At the same time, a force of compression is created in the barrel 450 and exerted on the melt mixture 34. The heaters 440 maintain the barrel temperature between 50 and 160° C. such that the melt mixture 34 stays at its molten state before pelletizing. A thoroughly mixed polymer mixture 36 is then ejected out through the nozzle 460. A die head (not shown) is attached to the end of the nozzle 460 and polymer 36 is formed into pellets 40 as shown in FIG. 2B. It should be understood that the formation of the master batch composition does not require the step of pre-foaming.

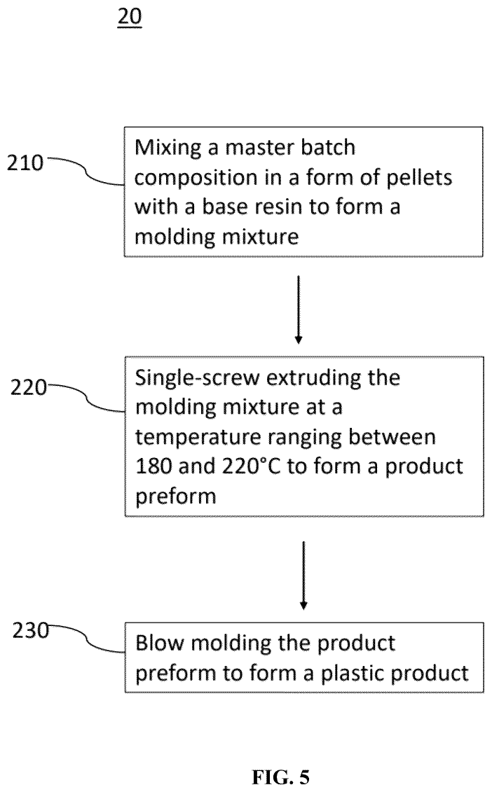

Turning to FIG. 5, a method 20 of manufacturing a weight-reduced plastic using the master batch composition is shown. In step 210, the master batch composition in a form of pellets as shown in FIG. 2B is mixed with a base plastic resin to form a blow molding mixture. The base plastic resin is selected from polyethylene and polypropylene. The content of the master batch composition in the weight-reduced plastic ranges between 1 and 10 wt %. The master batch composition can mix well with the base plastic resin because the master batch composition is in the form of pellet instead of powder and has similar pellet size as the base plastic resin, and additional foaming agent is not required in the process.

In step 220, the molding mixture undergoes single-screw extrusion at a temperature ranging between 180 and 220° C. to form a product preform. Turning to FIG. 6 in conjunction with FIG. 5, a portion of the single-screw extruder 4000 is shown. The nozzle 460 of the single-screw extruder 4000 is coupled to a die head 530 and an air supply system 520. When the molding mixture is fed into the single-screw extruder 4000, it is compressed and heated at a temperature ranging between 180 and 220° C. The single-screw extruder has a screw rotation speed ranging between 15 and 17 Hz. The molten molding mixture 52 is ejected out of the nozzle 460 to the die head 530. After the molten molding mixture 52 comes out from the nozzle 460, the molten molding mixture 52 passes through the die head 530 and is formed into a product preform 54. This product preform 54 is the blank for the next step.

An air supply system 520 is connected to the die head 530, and its pipe goes through the die head 530. A blow pin 522 at the end of the pipe of the air supply system 520 has the same outlet as the die head 530. The air supply system also has a valve 510 that is capable of controlling the flow of the air.

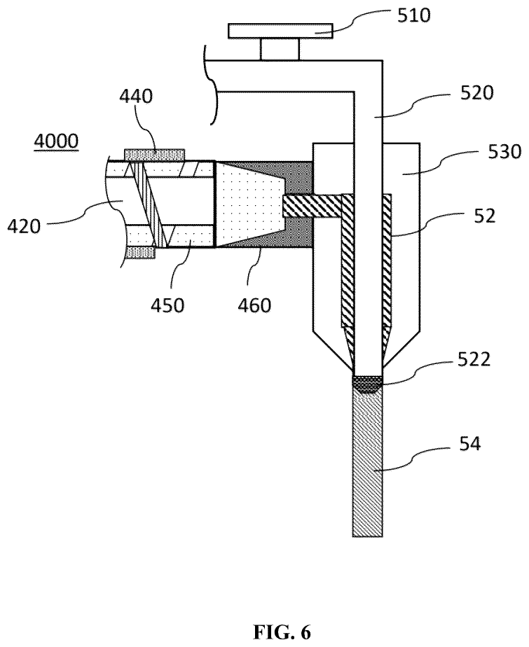

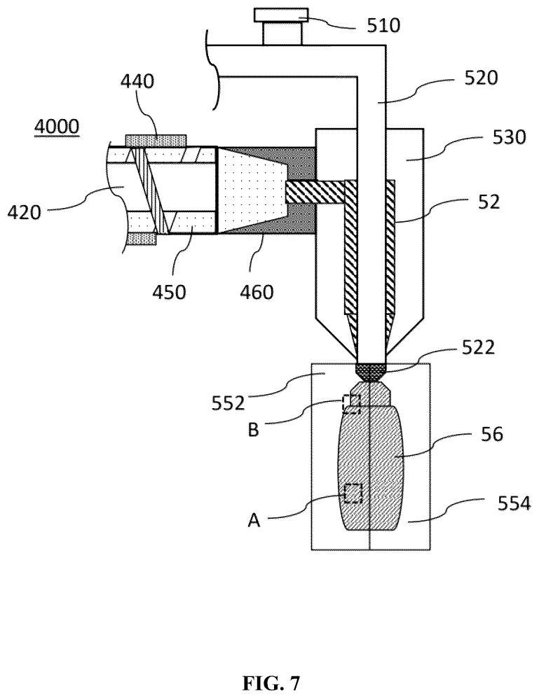

Referring back to FIG. 5, in step 230, the product preform 54 undergoes blow molding to form a plastic product. Turning to FIG. 7, a mold formed by two halves 552 and 554 with a cavity of a desirable configuration is used in the blow molding process. The product preform 54 is placed in the cavity formed by the two halves 552 and 554 of the mold. When the two halves 552 and 554 of the mold close on each other with the product preform 54, the valve 510 of the air supply system 520 is open, and the air is pumped into the cavity through the blow pin 522. A blow pressure of the air supply system 520 ranges between 0.25 and 0.6 MPa. In an embodiment, the blow pressure ranges between 0.25 and 0.35 MPa. The product preform 54 inflates and presses against the walls of the mold to form a plastic product 56. The die head 530 is heated to a die temperature ranging between 170 and 230° C.

### EXAMPLES

Table 1 shows foamed plastic with different compositions and their properties. In this example, foamed bottles are made without commercial foaming agent in B0 (control sample), with commercial foaming agent 1 (CFA 1) in B1 and commercial foaming agent 2 (CFA 2) in B2. In B3, the master batch composition which includes the core-shell foaming agent (CoreFA) is used. PE in Table 1 indicates polyethylene. In each bottle sample, if foaming agent is used, the foaming agent/master batch composition is approximately 3%, and no more than 3%, in the final foamed bottles. In Table 1, the ‘Weight Reduction’ column, B3, which uses the core-shell foaming agent, shows 17.5% weight reduction and a similar thickness as B0, which has 100% polyethylene. Although B1 shows similar weight reduction (17%) like B3 in comparison with B0, its thickness is more than one third (⅓) less than B0. B2 shows the most weight reduction of 20%. B2 has a thickness which is about one third (⅓) less than B0. However, B2 is prone to burst in its final form. The foamed plastic film of B2 also shows a distorted, wrinkled appearance. The results are calculated from a sample number of 3.

TABLE 1

| | | | | | Weight | Weight | Thickness |
|---|---|---|---|---|---|---|---|
| Sample | PE | CFA 1 | CFA 2 | CoreFA | (g) | Reduction | (mm) |
| B0 | 100% | 0% | 0% | 0% | 44.47 | — | 0.73 ± 0.02 |
| B1 | 97.5% | 2.5% | 0% | 0% | 36.66 | 17% | 0.48 ± 0.02 |
| B2 | 98% | 0% | 2% | 0% | 34.23 | 23% | 0.94 ± 0.15 |
| B3 | 97% | 0% | 0% | 3% | 36.71 | 17.5% | 0.72 ± 0.05 |

Table 2 shows foamed plastic bottles formed under different condition of blow molding. B0 is the control sample with 100% PE, B4 has 2.5% master batch composition (MBC), B5 and B6 have 3% master batch composition respectively. The blow molding conditions for each sample are also listed in Table 2. The temperature of the single-screw extruder is indicated as SSE. The temperature of the die head is indicated as Die. In this example, the screw rotation speed is maintained at 16.8 Hz, the period of time of blowing is 13 seconds, and the blow pressure is 0.3 MPa. In this example, the addition of the core-shell foaming agent ensures weight reduction and a desirable thickness of the final foamed plastic bottle. By slightly increasing the temperature at the die head from 186 to 190° C., the weight is further reduced.

TABLE 2

| | | | Weight | Thickness | SSE | Die |
|---|---|---|---|---|---|---|
| Sample | PE | MBC | Reduction | (mm) | (° C.) | (° C.) |
| B0 | 100% | 0% | — | 0.73 | 180 | 180 |
| B4 | 97.5% | 2.5% | 12.6% | 0.73 | 190 | 190 |
| B5 | 97% | 3% | 12.4% | 0.78 | 190 | 186 |
| B6 | 97% | 3% | 16.7% | 0.74 | 190 | 190 |

Table 3 shows a chart including 10 repeated cycles of manufacturing the sample bottles discussed in Table 2. Table 3 shows that the quality of the foamed plastic bottle using the master batch composition is consistent, and the goal of weight reduction can be achieved by adding the master batch composition.

TABLE 3

| Cycle | B0 | B4 | B5 | B6 |
|---|---|---|---|---|
| 1 | 44.5 | 38.5 | 38.5 | 37.5 |
| 2 | 44.5 | 39.5 | 38.5 | 37.5 |
| 3 | 44.5 | 39.5 | 38.5 | 37 |
| 4 | 44.5 | 39 | 38.5 | 37.5 |
| 5 | 44.5 | 39 | 39.5 | 37 |
| 6 | 44.5 | 38.5 | 39 | 37 |
| 7 | 44.5 | 39 | 39 | 37 |
| 8 | 44.5 | 38 | 39.5 | 36.5 |
| 9 | 44.5 | 39 | 38.5 | 37 |
| 10 | 44.5 | 39 | 39.5 | 36.5 |
| Weight Avg (g) | 44.5 | 38.9 | 39 | 37.05 |
| Range | 0 | 1.5 | 1 | 1 |
| Std Dev | 0 | 0.436 | 0.447 | 0.350 |
| % Wt reduction | 0 | 12.58% | 12.36% | 16.74% |
| Thickness (mm) | 0.73 | 0.73 | 0.78 | 0.74 |

The mechanical strength of the foamed plastic bottle formed with the master batch composition of the present invention is tested and shown in Table 4. B0 is the control sample made without the addition of the master batch composition but PE alone. According to Table 4, the mechanical strength (e.g., tensile) retention is greater than 85% in general. That is, the addition of the master batch composition in the foamed plastic bottle can reduce the product weight and at the same time retain similar thickness and at least 85% (in comparison with the control sample) of mechanical strength.

TABLE 4

| | | | Tensile | | | |
|---|---|---|---|---|---|---|
| | | | strength | Tensile | Young's | Young's |
| | Weight | Thickness | at yield | strength | modulus | modulus |
| Sample | Reduction | (mm) | (MPa) | retention | (Mpa) | retention |
| B0 | — | 0.73 | 39.3 ± 0.7 | — | 1968 | — |
| B4 | 12.6% | 0.73 | 36.5 ± 1.1 | 92.8% | 1821 | 92.5% |
| B5 | 12.4% | 0.78 | 35.8 ± 0.9 | 91.1% | 1850 | 94.0% |
| B6 | 16.7% | 0.74 | 34.9 ± 0.4 | 88.7% | 1790 | 91.0% |

The pore size of the foamed plastic bottle is further investigated under SEM imaging and shown in Table 5. Referring back to FIG. 7, the samples are cut out from the body part A of the foamed bottles. The average pore size ranges between approximately 25 and 45 μm. In particular, sample B6, which has 3% master batch composition and is formed under 190° C. single-screw extruder and 190° C. die head has a small and uniform average pore size at approximately 30 μm. The results are calculated from a sample number more than 100.

TABLE 5

| | | |
|---|---|---|
| | Weight | |
| Sample | Reduction | Avg Pore Size (μm) |

| | | | |
|---|---|---|---|
| B4 | 12.6% | Long diameter | 90 ± 31 |
| | | Short diameter | 15 ± 4 |
| | | Pore Size R′ | 37 ± 6 |
| B5 | 12.4% | Long diameter | 75 ± 26 |
| | | Short diameter | 12 ± 5 |
| | | Pore Size R′ | 32 ± 6 |
| B6 | 16.7% | Long diameter | 72 ± 27 |
| | | Short diameter | 13 ± 4 |
| | | Pore Size R′ | 30 ± 5 |

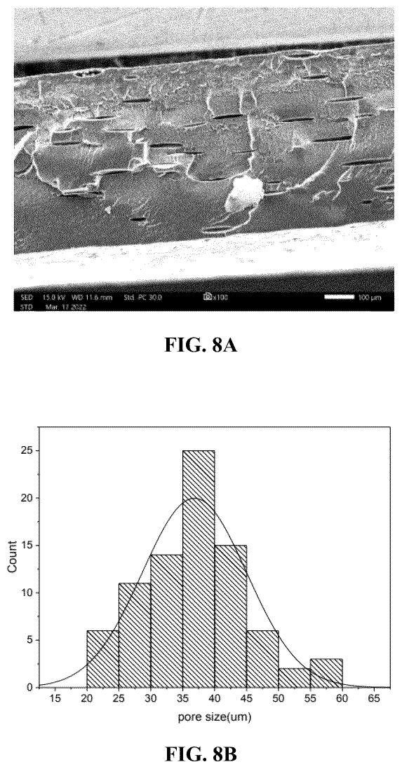

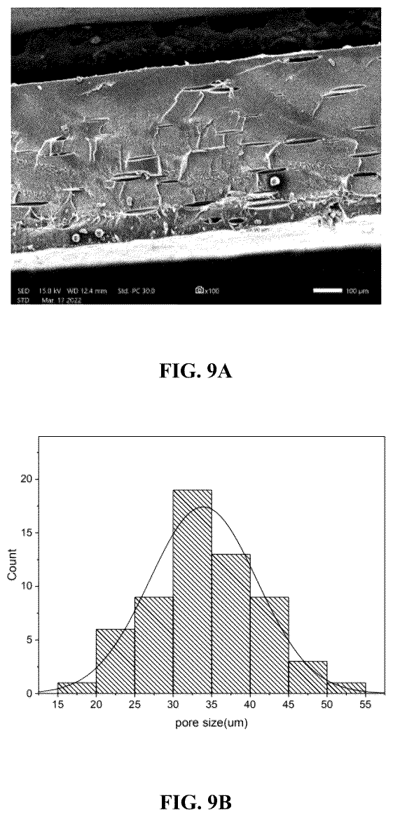

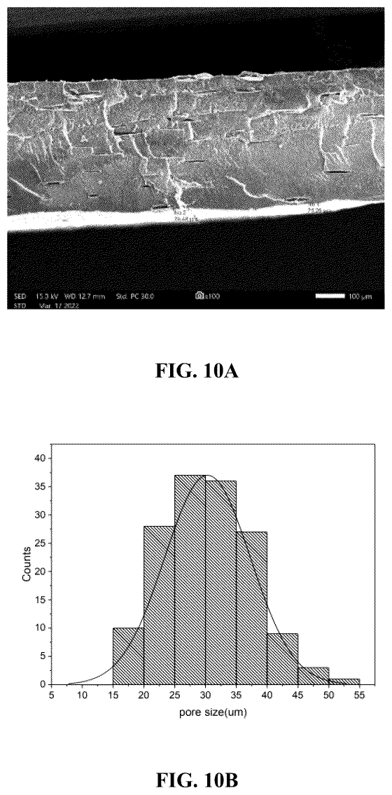

Turning to FIGS. 8A and 8B, an SEM image of sample B4 is shown in FIG. 8A, a particle size distribution is shown in FIG. 8B. In FIG. 8A, the pores are measured by their width and length. In FIG. 8B, sample B4 has pore size ranging between 20 and 60 μm, and a peak of pore size ranging between 35 and 40 μm is observed. Turning to FIGS. 9A and 9B, an SEM image of sample B5 is shown in FIG. 9A, a particle size distribution is shown in FIG. 9B. In FIG. 9B, sample B5 has pore size ranging between 15 and 55 μm, and a peak of pore size ranging between 30 and 35 μm is observed. Turning to FIGS. 10A and 10B, an SEM image of sample B6 is shown in FIG. 10A, a particle size distribution is shown in FIG. 10B. By increasing the die head temperature to 190° C., the foamed plastic bottle has a smoother surface. In FIG. 10B, sample B6 has pore size ranging between 15 and 55 μm, and a cluster of peaks of pore size ranging between 25 and 35 μm is observed.

The pore size of the foamed plastic bottle is further investigated under SEM imaging and shown in Table 6. Referring back to FIG. 7, the samples are cut out from the neck B of the foamed bottles which tapers toward the outlet of the bottle. The average pore size ranges between approximately 25 and 50 μm. In particular, sample B6, which has 3% master batch composition and is formed under 190° C. single-screw extruder and 190° C. die head has a small and uniform average pore size at approximately 37 μm. The results are calculated from a sample number of more than 100.

TABLE 6

| | | |
|---|---|---|
| | Weight | |
| Sample | Reduction | Avg Pore Size (μm) |

| | | | |
|---|---|---|---|
| B4 | 12.6% | Long diameter | 45 ± 13 |
| | | Short diameter | 29 ± 7 |
| | | Pore Size R′ | 35 ± 7 |
| B5 | 12.4% | Long diameter | 47 ± 12 |
| | | Short diameter | 30 ± 6 |
| | | Pore Size R′ | 34 ± 7 |
| B6 | 16.7% | Long diameter | 45 ± 11 |
| | | Short diameter | 32 ± 8 |
| | | Pore Size R′ | 37 ± 5 |

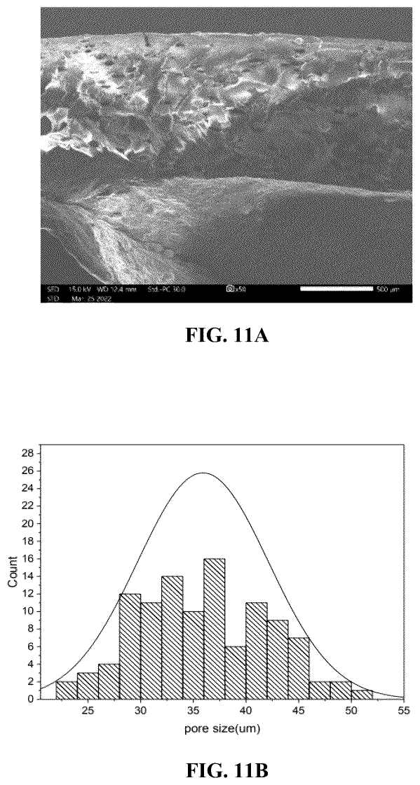

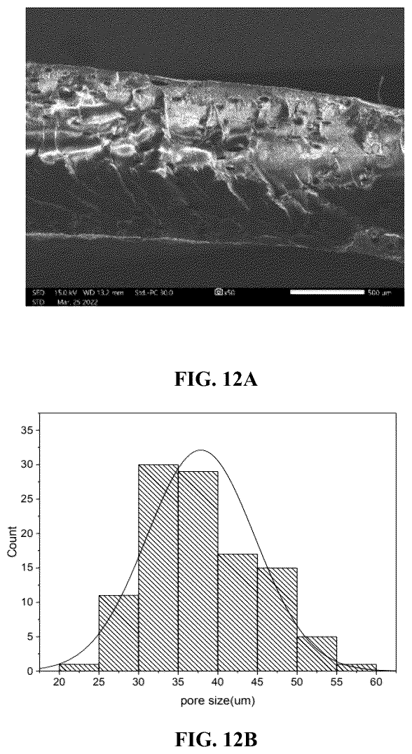

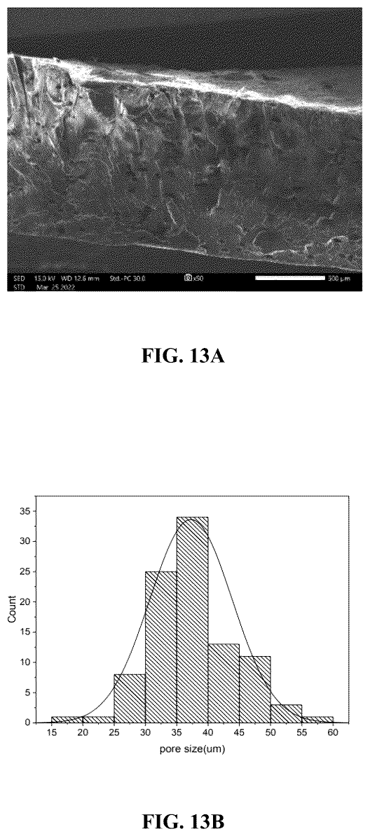

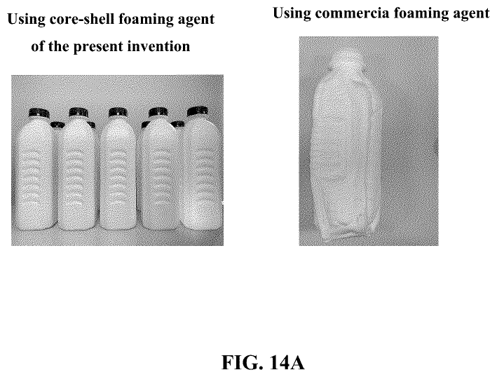

Turning to FIGS. 11A and 11B, an SEM image of sample B4 is shown in FIG. 11A, a particle size distribution is shown in FIG. 11B. In FIG. 11A, the pores are measured by their width and length. In FIG. 11B, sample B4 has pore size ranging between approximately 22.5 and 52.5 μm, and a cluster of peaks of pore size ranging between 27.5 and 37.5 μm is observed. Turning to FIGS. 12A and 12B, an SEM image of sample B5 is shown in FIG. 12A, a particle size distribution is shown in FIG. 12B. In FIG. 12B, sample B5 has pore size ranging between 20 and 60 μm, and a twin peak of pore size ranging between 30 and 40 μm is observed. Turning to FIGS. 13A and 13B, an SEM image of sample B6 is shown in FIG. 13A, a particle size distribution is shown in FIG. 13B. By increasing the die head temperature to 190° C., the foamed plastic bottle B6 has a smoother surface as shown in FIG. 13A. In FIG. 13B, sample B6 has pore size ranging between 15 and 60 μm, and a peak of pore size ranging between 35 and 40 μm is observed.

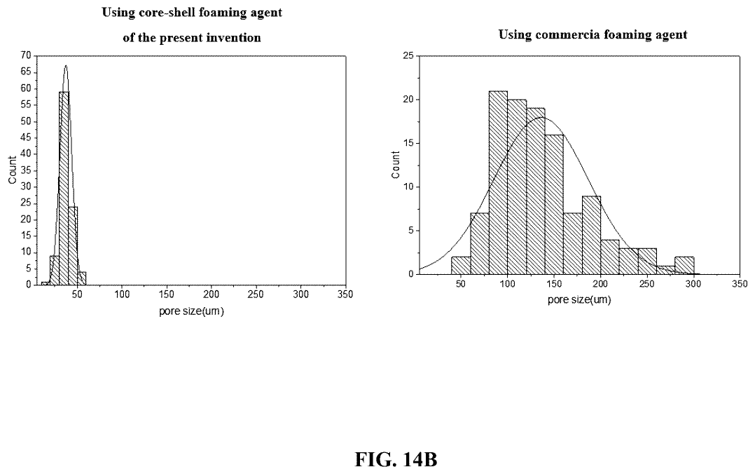

In general, the blowing pressure during EBM processing tends to be relatively high, typically ranging between 0.25 to 0.6 MPa, the choice of carrier resin is therefore crucial and should meet specific requirements, including high-temperature resistance and the ability to withstand high pressure. FIG. 14a shows that the bottle formed using the foaming masterbatch with bi-component carrier resins and core-shell foaming agent of the present invention via EBM maintains a normal appearance, whereas under the same conditions, the use of a commercial foaming masterbatch with only one carrier resin results in a compressed bottle appearance. Furthermore, the plastic bottle with the core-shell foaming agent developed through EBM technology in this invention can achieve pore sizes smaller than 70 micrometers for all pores (FIG. 14b) and ensure a compression strength of 17.2 kgf for the empty bottle. Simultaneously, the weight of the bottles in this invention is reduced by at least 12% compared to bottles without foaming.

In general, when the master batch composition of the present invention is used, the foamed plastic product has lower weight compared to plastic products without the master batch composition. The weight-reduced plastic product maintains a smooth surface and small and even pore size smaller than 100 μm. The mechanical strength of the foamed plastic product retains at least 85% of a conventional PE plastic product without foaming agent. The weight-reduced plastic product can satisfy the existing food container standards. By the addition of the master batch composition for approximately 2 to 3% to the base resin, a significant weight reduction is observed with a similar durability.

As used herein, terms “approximately”, “basically”, “substantially”, and “about” are used for describing and explaining a small variation. When being used in combination with an event or circumstance, the term may refer to a case in which the event or circumstance occurs precisely, and a case in which the event or circumstance occurs approximately. As used herein with respect to a given value or range, the term “about” generally means in the range of ±10%, ±5%, ±1%, or ±0.5% of the given value or range. The range may be indicated herein as from one endpoint to another endpoint or between two endpoints. Unless otherwise specified, all the ranges disclosed in the present disclosure include endpoints. The term “substantially coplanar” may refer to two surfaces within a few micrometers (μm) positioned along the same plane, for example, within 10 μm, within 5 μm, within 1 μm, or within 0.5 μm located along the same plane. When reference is made to “substantially” the same numerical value or characteristic, the term may refer to a value within ±10%, ±5%, ±1%, or ±0.5% of the average of the values.

What is claimed is:

1. A method of preparing a master batch composition for a weight-reduced plastic product, comprising:
mixing a master batch composition to form a melt mixture in an internal mixer at a first temperature, wherein the master batch composition comprises a bi-component carrier resin, a core-shell foaming agent, and at least one lubricant, and the first temperature is a melting temperature of the bi-component carrier resin, wherein the core-shell foaming agent includes at least one outer polymeric shell and at least one inner foaming agent core, the polymeric outer polymeric shell encapsulates the inner foaming agent core, and the inner foaming agent core includes alkane;
single-screw extruding and pelletizing the melt mixture at a second temperature ranging between 50 and 160° C. to form pellets;
mixing the master batch composition in a form of pellets with a base plastic resin to form a molding mixture in an internal mixer, wherein the master batch composition has a particle size similar to that of the base plastic resin, thereby eliminating the need for additional foaming agents;
single-screw extruding the molding mixture at a temperature ranging between 180 and 220° C. to form a product preform; and
extrusion blow molding the product preform to form the weight-reduced plastic product, wherein the weight-reduced plastic product has a foaming pore size from 10 to 80 μm, and wherein the weight-reduced plastic product contains the master batch composition ranging from 1 to 10 wt %.

2. The method of claim 1, wherein step of mixing a master batch composition to form a melt mixture in an internal mixer at a first temperature does not require pre-foaming.

3. The method of claim 1, wherein step of extrusion blow molding the product preform to form the weight-reduced plastic product comprising:
heating a mold with a cavity according to the desired final shape of the weight-reduced plastic product to a temperature between 170° C. and 230° C.;
placing the product preform into the cavity formed by two halves of the mold;
introducing air into the cavity through a supply system, wherein the supply system has a blowing pressure ranges between 0.25 and 0.6 MPa,
wherein the product preform is subjected to air compression, causing the product preform to expand and conformingly overlay walls of the two halves of the mold, resulting in the formation of the weight-reduced plastic product.

4. The method of claim 1, wherein the master batch composition comprises 40 to 90 wt % of the bi-component carrier resin, 10 to 50 wt % of the core-shell foaming agent, and 1 to 30 wt % of at least one lubricant.

5. The method of claim 1, wherein the single-screw extruding comprises a die temperature ranging between 170 and 230° C., a screw rotation speed ranging between 15 and 17 Hz, and a blow pressure ranging between 0.25 and 0.6 MPa.

6. The method of claim 1, wherein the melting temperature of the bi-component carrier resin is in a range of 50° C. to 160° C.

7. The method of claim 1, wherein the bi-component carrier resin comprises thermoplastic polymers and their blends selected from polyethylene (PE) and ethylene vinyl acetate (EVA).

8. The method of claim 7, wherein the polyethylene comprises one or more linear low-density polyethylene, low-density polyethylene, and high-density polyethylene.

9. The method of claim 8, wherein the bi-component carrier resin is a copolymer of linear low-density polyethylene and ethylene vinyl acetate.

10. The method of claim 1, wherein the outer polymeric shell is selected from the group consisting of poly lactic acid (PLA), poly(lactic-co-glycolic acid)(PLGA), polystyrene (PS), poly methacrylate (PMA), poly methyl Methacrylate (PMMA), or polymers comprising one or more monomers of acrylonitrile, methacrylonitrile, 3-butene nitrile, methacrylate, ethyl acrylate, propyl acrylate, butyl acrylate, methyl methacrylate, methyl ethyl acrylate, glycidyl methacrylate, or any combination thereof, and the inner foaming agent core is selected from the group consisting of pentane, butane, n-hexane, n-heptane, isooctane or any combination thereof.

11. The method of claim 1, wherein the at least one lubricant comprises one or more lubricant selected from paraffin oil, paraffin wax, stearic acid and their blends.

12. The method of claim 1, wherein the base plastic resin comprises one or more polyethylene and polypropylene.

13. The method of claim 1, wherein the weight-reduced plastic product achieves a weight reduction ranging from 12.4% to 16.7% while maintaining the same thickness compared to a plastic product without the master batch composition, and the weight-reduced plastic product exhibits a tensile strength retention of greater than 85%.
